(19) United States
(12) Patent Application Publication
(10) Pub. No.: US 2025/0174834 A1
(43) Pub. Date: May 29, 2025

(54) POWER STORAGE MODULE

(71) Applicant: TOYOTA JIDOSHA KABUSHIKI KAISHA, Toyota-shi (JP)

(72) Inventor: Yudai Hasegawa, Toyota-shi (JP)

(73) Assignee: TOYOTA JIDOSHA KABUSHIKI KAISHA, Toyota-shi (JP)

(21) Appl. No.: 18/922,409

(22) Filed: Oct. 22, 2024

(30) Foreign Application Priority Data
Nov. 24, 2023 (JP) 2023-199404

(51) Int. Cl. H01M 50/474; H01M 50/489

(52) U.S. Cl. CPC H01M 50/474; H01M 50/489

(57) ABSTRACT

Each of power storage cells stacked in the power storage module of the present disclosure includes a spacer that seals between edges of the current collectors facing each other to form an accommodation space in which an electrolytic solution is accommodated, and a reinforcing member that reinforces an uncoated portion of the current collector on which an active material layer is not coated. The reinforcing member has a portion disposed along the uncoated portion so as to straddle the peripheral edge portion of the active material layer and the spacer. The reinforcing members adjacent to each other in the stacking direction have non-overlapping portions that do not overlap each other in the peripheral portion of the active material layer.

### CROSS-REFERENCE TO RELATED APPLICATION

This application claims priority to Japanese Patent Application No. 2023-199404 filed on Nov. 24, 2023, incorporated herein by reference in its entirety.

### BACKGROUND

### 1. Technical Field

The present disclosure relates to a power storage module.

### 2. Description of Related Art

Japanese Unexamined Patent Application Publication No. 2022-069042 (JP 2022-069042 A) discloses a power storage cell including a positive electrode and a negative electrode, a separator, a spacer, and a reinforcing member. The positive electrode and the negative electrode have active material layers on surfaces of current collectors formed of a metal foil on one side. The positive electrode and the negative electrode are disposed such that the active material layers face each other. The separator is disposed between the positive electrode and the negative electrode and is interposed between the active material layers. The spacer is disposed between the positive electrode and the negative electrode and forms an accommodation space in which an electrolyte is accommodated by sealing edges of the current collectors to surround the active material layers. The reinforcing members reinforce uncoated portions in the current collectors where the active material layers are not located. The current collectors have the uncoated portions between the spacer and the active material layers in a view from a facing direction of the active material layers of the positive electrode and the negative electrode. The reinforcing members are disposed along the uncoated portions to straddle boundaries between the active material layers and the uncoated portions and boundaries between the spacer and the uncoated portions in a view from the facing direction.

### SUMMARY

In order to reduce breakage or bending of a current collector foil due to a reduced pressure or thermal shock, reinforcing members may be disposed to straddle electrode peripheral portions and electrode coated portions in order to increase the strength of the entire electrode bodies. FIG. 5 shows an example in which the thickness due to overlapping of the reinforcing members increases when a portion of the spacer is disposed as the reinforcing members to straddle the electrode peripheral portions and the electrode coated portions. As shown in FIG. 5, the thickness increases in overlapping portions 40 where an electrode coated portion (negative electrode 14) of the current collector 10 and reinforcing members 22B (parts of a spacer 20) overlap each other. In a power storage module (hereinafter, sometimes simply referred to as a “module”) in which a plurality of such electrode bodies is stacked, an increase in thickness of the overlapping portions 40 becomes remarkable, and an energy density of the module may be lowered.

An object of the present disclosure is to provide a power storage module capable of reducing an increase in thickness due to overlapping portions between electrode coated portions and reinforcing members of current collectors and reducing a decrease in energy density of the power storage module.

Means for solving the above problem includes the following embodiments.

<1> A power storage module in which a plurality of power storage cells is stacked, each power storage cell includes:
a positive electrode and a negative electrode that have active material layers disposed to face each other, the active material layers being applied to center regions on surfaces of facing current collectors on one side;
a separator that is interposed between the active material layers of the positive electrode and the negative electrode;
a spacer that is arranged to surround the active material layers and forms an accommodation space in which an electrolyte is accommodated by sealing a part between edges of the facing current collectors; and
reinforcing members that reinforce uncoated portions of the current collectors to which the active material layers are not applied,
in which in a view from a facing direction of the active material layers, the uncoated portions are present between the spacer and the active material layers in the current collectors,
in a view from the facing direction, the reinforcing members have portions that are intermittently disposed along the uncoated portions to straddle peripheral edges of the active material layers and the spacer, and
in a view from the facing direction, the reinforcing members that are adjacent to each other in the facing direction have non-overlapping portions that do not overlap each other at the peripheral edges of the active material layers.
   <2> The power storage module according to <1>, in which
in a view from the facing direction, the reinforcing members have uneven portions at the peripheral edges of the active material layers, and
the reinforcing members that are adjacent to each other in the facing direction have the non-overlapping portions in which the uneven portions do not overlap each other at the peripheral edges of the active material layers.
   <3> The power storage module according to <1> or <2>, in which
the non-overlapping portions of the reinforcing members are not adjacent to each other in the facing direction.
   <4> The power storage module according to any one of <1> to <3>, in which
the spacer and the reinforcing members are formed as the same integrated member.

According to the present disclosure, there is provided a power storage module capable of reducing an increase in thickness due to overlapping portions between electrode coated portions of current collectors and reinforcing members and reducing a decrease in energy density of the power storage module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view illustrating an example of an external appearance of a power storage module according to the present disclosure;

FIG. 2 is a schematic diagram illustrating an example of a power storage module configured by alternately stacking power storage cells having comb-shaped spacers;

FIG. 3A is a schematic configuration diagram illustrating a cross section of a I-I line of FIG. 2;

FIG. 3B is a schematic configuration diagram illustrating a cross section of a II-II line of FIG. 2;

FIG. 4A is a schematic diagram showing a configuration in which spacers are arranged alternately in the separating layers so that the reinforcing members (portions of the spacers) do not overlap;

FIG. 4B is a schematic diagram showing a configuration in which spacers are arranged alternately in the separating layers so that the reinforcing members (portions of the spacers) do not overlap;

FIG. 4C is a schematic diagram showing a configuration in which spacers are arranged alternately in the separating layers so that the reinforcing members (portions of the spacers) do not overlap;

FIG. 4D is a schematic diagram showing a configuration in which spacers are alternately arranged in the separating layers so that the reinforcing members (portions of the spacers) do not overlap with each other; and

FIG. 5 is a schematic configuration diagram illustrating an example of the amplification of the thickness by the overlapping portion of the reinforcing member (a part of the spacer).

### DETAILED DESCRIPTION OF EMBODIMENTS

Hereinafter, a power storage module according to the present disclosure will be described with reference to the drawings. In the drawings, the same or corresponding parts are denoted by the same reference numerals, reference numerals are appropriately omitted in the same drawings, and descriptions are also appropriately omitted.

The power storage module according to the present disclosure has a configuration in which reinforcing members are laminated so that overlapping portions in which the electrode coating portions (active material layers) and the reinforcing members overlap each other in the stacking direction of the plurality of power storage cells become discontinuous in the stacking direction. As a result, the amplification of the thickness at the time of stacking the power storage cells is relaxed, and a decrease in the energy density as a module is suppressed.

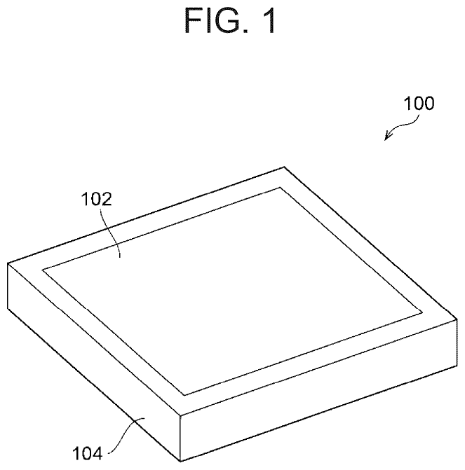

FIG. 1 is a schematic perspective view illustrating an example of an external appearance of a power storage module according to the present disclosure. The power storage module 100 according to the present disclosure is, for example, a rectangular parallelepiped as shown in FIG. 1. The power storage module 100 includes an electrode stack 102 including a stacked bipolar electrode group, a resin body 104 surrounding and holding a side surface of the electrode stack 102, and an electrolytic solution (not shown). The power storage module 100 according to the present disclosure has a configuration in which a plurality of power storage cells is stacked. The length and width of the power storage module 100 are not particularly limited, but may be greater than 1 m.

The power storage cell includes a positive electrode and a negative electrode, a separator, a spacer, and a reinforcing member formed on one surface of each of the opposing current collectors. The reinforcing member reinforces an uncoated portion of the current collector on which the active material layer of the positive electrode or the negative electrode is not coated. The reinforcing member may be a member different from the spacer, or the same member integrated with the spacer, that is, the spacer and the reinforcing member may be integrally formed. Hereinafter, an embodiment in which a spacer and a reinforcing member are integrally formed will be described as an example of the power storage module according to the present disclosure.

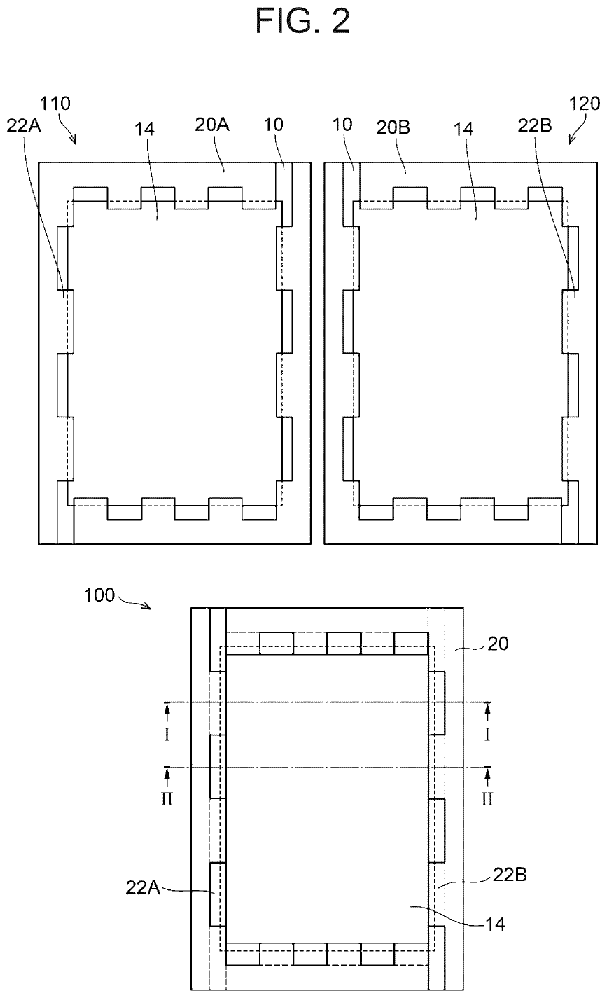

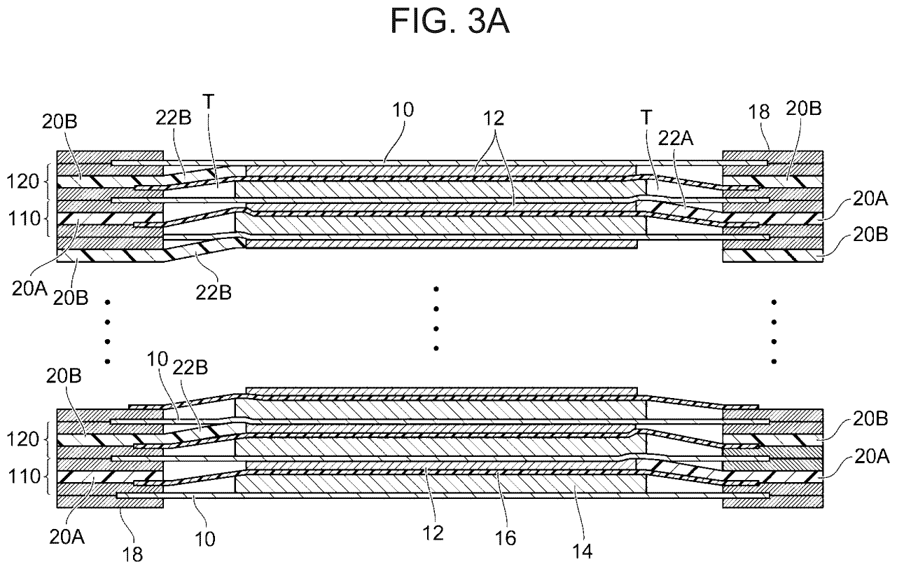

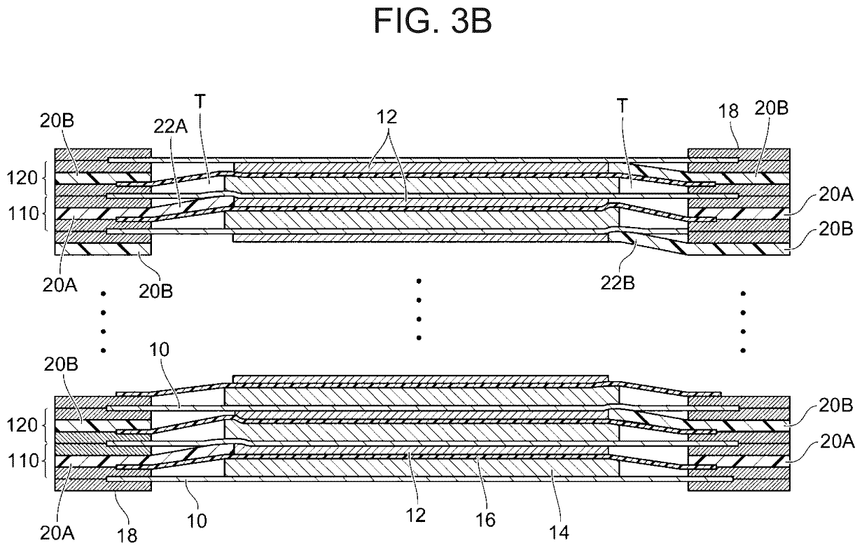

FIG. 2 shows a power storage module 100 configured by alternately stacking power storage cells 110, 120. FIG. 3A is a schematic cross-sectional view showing a cross section of I-I line in FIG. 2, and FIG. 3B is a schematic cross-sectional view showing a cross section of II-II line in FIG. 2. In FIG. 2, the positive electrode 12, the separator 16, and the seal portion 18 are not shown for convenience of explanation.

The power storage cell 110 includes a positive electrode 12 and a negative electrode 14 formed on one surface of an opposing current collector 10, separators 16, a spacer 20A, and a reinforcing member 22A. The power storage cell 120 includes a positive electrode 12 and a negative electrode 14 formed on one surface of the current collector 10 facing each other, separators 16, a spacer 20B, and a reinforcing member 22B.

The positive electrode 12 and the negative electrode 14 are formed such that the active material layers coated on the central regions of the respective surfaces of the current collectors 10 facing each other are arranged to face each other.

The separator 16 is interposed between the active material layers 12 and 14 of the positive electrode 12 and the negative electrode 14 (between the positive electrode 12 and the negative electrode 14).

The spacer 20A, 20B is disposed so as to surround the active material layers 12 and 14, and seals the edge portions of the current collectors 10 facing each other to form an accommodation space T in which the electrolyte solution is stored.

When viewed from the direction in which the active material layers 12 and 14 face each other (the same as the stacking direction of the power storage cells 110, 120), the current collector 10 has an uncoated portion between the spacer 20A, 20B and the active material layers 12 and 14.

The reinforcing member 22A, 22B reinforces an uncoated portion of the current collector 10 on which the active material layers 12 and 14 are not coated. When viewed from the facing direction of the active material layers 12 and 14, the reinforcing member 22A, 22B has a portion disposed along the uncoated portion so as to straddle the peripheral edge portions of the active material layers 12 and 14 and the spacer 20A, 20B.

In the present embodiment, the spacer 20A and the reinforcing member 22A are formed as the same member in which the spacer 20B and the reinforcing member 22B are integrated.

As illustrated in FIG. 2, the spacer 20A, 20B in the respective power storage cells 110, 120 has an uneven shape (sometimes referred to as “comb-tooth shape”) when viewed from the opposite direction (the same as the stacking direction). In the case of such a comb-shaped spacer 20A, 20B, the recess functions as a spacer 20A, 20B for forming the accommodation space T of the electrolyte solution. The protrusion functions as a reinforcing member 22A, 22B that reinforces the uncoated portion to which the active material layers 14 are not coated.

In the present embodiment, the comb-shaped spacer 20A, 20B is disposed in the space portion on the positive electrode 12 side, and the end portion of the reinforcing member 22A, 22B overlaps the peripheral edge portion on the negative electrode 14 side. As described above, since the power storage cells 110, 120 are alternately stacked, the overlap between the reinforcing member (comb-teeth portion) 22 and the negative electrode 14 does not accumulate in the stacking direction, the bulge is reduced in the module, and the unevenness of the module is reduced. The total thickness of the module does not increase, and the reduction of the energy density is suppressed. Further, the space portion is required for generating gases by charging and discharging, and the space portion (accommodation space) Y can be secured in a wide manner by forming the spacer 20A, 20B in a comb-shape.

Each of the power storage cells 110, 120 is configured such that, when alternately stacked, the positions of the convex portions of the spacers in one of the power storage cells are the positions of the concave portions of the spacers of the other power storage cell. Therefore, by configuring the power storage module by alternately stacking the power storage cells 110, 120, the protruding portions of the spacers that function as the reinforcing members of the power storage cells 110, 120 adjacent to each other in the stacking direction do not continuously overlap each other in the stacking direction. When the power storage cells 110, 120 are alternately stacked, the reinforcing member 22A, 22B adjacent to each other in the opposing direction (stacking direction) become non-overlapping portions in which the uneven portions do not overlap at the peripheral portions of the active material layers 12 and 14. Therefore, during stacking of the power storage cells, the amplification of the thickness due to the overlap of the reinforcing members in the stacking direction is relaxed, and a decrease in the energy density as a module is suppressed.

Although the recessed portions of the reinforcing members 22A, 22B are non-overlapping portions, even if the recessed portions of the reinforcing members 22A, 22B are adjacent to each other in the facing direction when the power storage cells 110, 120 are overlapped, the accumulation of the overlapping of the reinforcing members 22 and the negative electrode 14 cannot be suppressed. Therefore, it is preferable that the non-overlapping portions (recessed portions) of the reinforcing member 22A, 22B are not adjacent to each other.

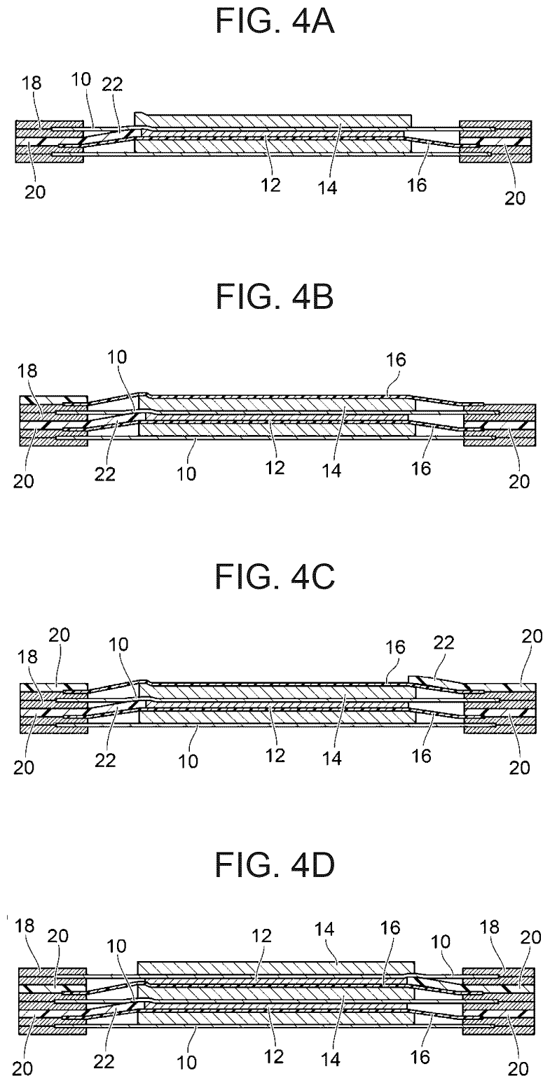

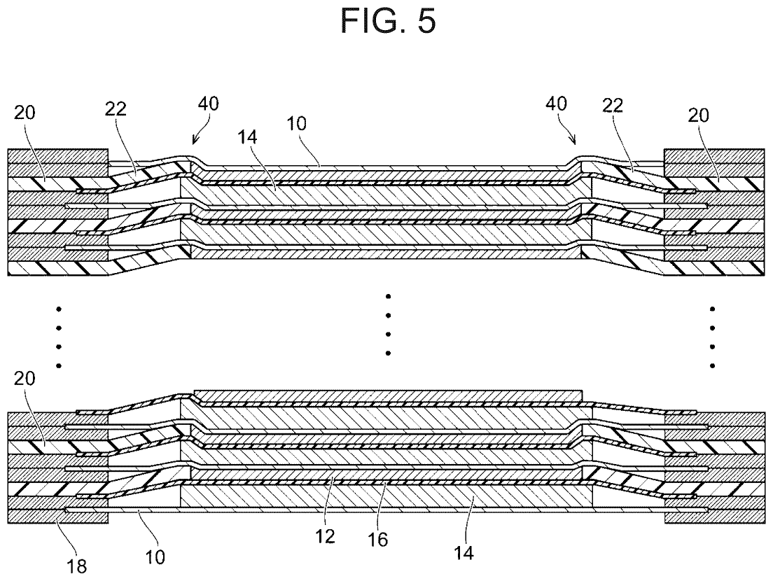

The method of manufacturing the power storage module 100 according to the present disclosure is not particularly limited. By sequentially stacking the electrode bodies and the spacers, the power storage module according to the present disclosure can be manufactured. Hereinafter, an example of a method for manufacturing a power storage module according to the present disclosure will be described. FIGS. 4A to 4D illustrate examples of a method for manufacturing a power storage module according to the present disclosure.

First, as shown in FIG. 4A, an electrode assembly in which the seal portion 18 is welded to the outer periphery of the current collector 10 is laminated. Next, as shown in FIG. 4B, the separators 16 are stacked on the negative electrode 14. Next, as shown in FIG. 4C, comb-shaped spacers 20 are laminated. The comb-shaped spacers 20 are alternately arranged in a separation layer so that comb-teeth portions (reinforcing members) of adjacent cells do not overlap each other in the stacking direction. Next, as shown in FIG. 4D, the seal portion 18 is welded to the outer periphery.

By repeating the stacking in this manner, a power storage module in which a plurality of power storage cells in which the accumulation of the overlap between the reinforcing member 22 and the negative electrode 14 is suppressed are stacked is obtained.

Hereinafter, the constituent materials and the like of the power storage module according to the present disclosure will be described in detail, but the constituent materials and the like of the power storage module according to the present disclosure are not limited to the following description.

### Electrode Stack

The electrode stack 102 is a rectangular parallelepiped. The electrode stack 102 includes a plurality of bipolar electrodes stacked via the separator 16. As shown in FIGS. 3A and 3B, the electrode stack 102 includes a plurality of bipolar electrodes, a plurality of separators 16, a positive electrode side terminal electrode (not shown), and a negative electrode side terminal electrode (not shown). The plurality of bipolar electrodes and the plurality of separators 16 are alternately stacked along the axial direction. The positive electrode side termination electrode is laminated with the separator 16 interposed therebetween on the bipolar electrode that is most positioned in one of the plurality of bipolar electrodes in the lamination direction. The negative electrode side termination electrode is laminated with the separator 16 interposed therebetween on the bipolar electrode that is most positioned in the other of the plurality of bipolar electrodes in the lamination direction.

The bipolar electrode includes a current collector 10, a positive electrode 12, and a negative electrode 14. The periphery of the current collector 10 is welded to the resin body 104 (the seal portion 18). The positive electrode 12 is formed on one surface of the current collector 10. The negative electrode 14 is formed on the other surface of the current collector 10. The bipolar electrode may have a known configuration.

The current collector 10 supplies current to the positive electrode 12 and the negative electrode 14 during discharging or charging of the power storage module 100. The current collector 10 includes, for example, aluminum foil, copper foil, nickel foil, titanium foil, stainless steel foil or the like. A coating layer may be formed on the surface of the current collector 10 by a known method (for example, plating, spray coating, or the like). The thickness of the current collector 10 may be 1 μm to 100 μm.

The positive electrode 12 includes a positive electrode active material (for example, a lithium composite metal oxide having a layered rock salt structure, a metal oxide having a spinel structure, a polyanionic compound, and the like) capable of absorbing and desorbing charge carriers. The positive electrode 12 may further include, if necessary, a conductive auxiliary agent (for example, carbon nanofibers or the like) for increasing the electronic conductivity, a binder (for example, polyvinylidene fluoride or the like), an electrolyte supporting salt (lithium salt) for increasing the ionic conductivity, a polymer electrolyte, and an additive (for example, trifluoropropylene carbonate, a filler as a reinforcing material or the like). The thickness of the positive electrode 12 may be 2 μm to 500 μm.

The negative electrode 14 includes a negative electrode active material (e.g., carbon (e.g., natural graphite, artificial graphite), a compound capable of alloying with lithium (e.g., silicon, tin, etc.)) capable of absorbing and desorbing charge carriers. The negative electrode 14 may further include, if necessary, a conductive auxiliary agent (for example, acetylene black or the like) for increasing the electron conductivity, a binder (for example, polyvinylidene fluoride or the like), an electrolyte supporting salt (lithium salt) for increasing the ionic conductivity, a polymer electrolyte, and an additive (for example, trifluoropropylene carbonate, a filler as a reinforcing material or the like). The thickness of the negative electrode 14 may be 2 μm to 500 μm. The thickness of the negative electrode 14 may be the same as or different from the thickness of the positive electrode 12. In the present embodiment, as shown in FIGS. 3A and 3B, the length of the negative electrode 14 is longer than the length of the positive electrode 12.

### Separator

The separator 16 maintains a gap between the positive electrode 12 and the negative electrode 14 to prevent the occurrence of a contact short circuit, and allows a charge carrier such as lithium ions (for example, lithium ions) to pass therethrough. The periphery of the separator 16 is welded to the resin body 104 (the seal portion 18). The separator 16 is held by a resin body 104. Examples of the separator 16 include a porous resin sheet and a nonwoven fabric. Examples of the material of the porous resin sheet include polyolefins (polypropylene, polyethylene, and the like). Examples of the material of the nonwoven fabric include polypropylene, polyethylene terephthalate, and methylcellulose. The separator 16 may have a known configuration.

### Resin Body

The resin body 104 forms the accommodation space T between the bipolar electrodes adjacent to each other in the stacking direction. In the accommodation space T, a positive electrode 12, a negative electrode 14, and a separator 16 are accommodated in a state of being contained in an electrolytic solution. In the present embodiment, the resin body 104 suppresses leaking of the electrolyte contained in the accommodation space T to the outside. The resin body 104 may prevent moisture from entering the accommodation space T from the outside of the power storage module 100. The resin body 104 suppresses leaking of the internal gas generated from the positive electrode 12 or the negative electrode 14 to the outside of the power storage module 100 due to charging, discharging, or the like.

The resin body 104 is a rectangular tubular body having a rectangular cross section. The resin body 104 includes a spacer 20 and a reinforcing member 22 in addition to the seal portion 18 that holds the peripheral edges of the current collector 10 and the separator 16.

The seal portion 18 is disposed for each of the current collector 10 and the separator 16 along the stacking direction. The seal portion 18 is a rectangular tubular object having a rectangular cross section. The seal portion 18 is welded to the periphery of the current collector 10. In the stacking direction, the adjacent seal portions 18 are welded to each other. Therefore, the peripheral edge of the current collector 10 and the peripheral edge of the separator 16 are held in a state of being embedded in the resin body 104.

Examples of the material of the resin body 104 (the seal portion 18, the spacer 20, and the reinforcing member 22) include polyethylene, polystyrene, acrylonitrile-butadiene-styrene copolymer synthetic resin (ABS resin), modified polypropylene, acrylonitrile styrene resin, and the like.

### Electrolytic Solution

The electrolytic solution is accommodated in the accommodation space T. The electrolytic solution may include a non-aqueous solvent and a lithium salt. Examples of the lithium salt include LiClO₄, LiAsF₆, LiPF₆, LiBF₄, LiCF₃SO₃, LiN(FSO₂)₂, LiN(CF₃SO₂)₂. Examples of the non-aqueous solvent include cyclic carbonates, cyclic esters, chain carbonates, chain esters, and ethers. The non-aqueous electrolyte solution may contain an additive (for example, lithium bis(oxalato)borate or the like) or the like.

What is claimed is:

1. A power storage module in which a plurality of power storage cells is stacked, each power storage cell includes:
a positive electrode and a negative electrode that have active material layers disposed to face each other, the active material layers being applied to center regions on surfaces of facing current collectors on one side;
a separator that is interposed between the active material layers of the positive electrode and the negative electrode;
a spacer that is arranged to surround the active material layers and forms an accommodation space in which an electrolyte is accommodated by sealing a part between edges of the facing current collectors; and
reinforcing members that reinforce uncoated portions of the current collectors to which the active material layers are not applied, wherein
in a view from a facing direction of the active material layers, the uncoated portions are present between the spacer and the active material layers in the current collectors,
in a view from the facing direction, the reinforcing members are intermittently disposed along the uncoated portions to straddle peripheral edges of the active material layers and the spacer, and
in a view from the facing direction, the reinforcing members that are adjacent to each other in the facing direction have non-overlapping portions that do not overlap each other at the peripheral edges of the active material layers.

2. The power storage module according to claim 1, wherein:
in a view from the facing direction, the reinforcing members have uneven portions at the peripheral edges of the active material layers; and
the reinforcing members that are adjacent to each other in the facing direction have the non-overlapping portions in which the uneven portions do not overlap each other at the peripheral edges of the active material layers.

3. The power storage module according to claim 1, wherein the non-overlapping portions of the reinforcing members are not adjacent to each other in the facing direction.

4. The power storage module according to claim 1, wherein the spacer and the reinforcing members are formed as the same integrated member.
